(19) United States
(12) Patent Application Publication
(10) Pub. No.: US 2004/0056938 A1
(43) Pub. Date: Mar. 25, 2004

(54) Media loading of an imaging drum

(75) Inventor: Roger S. Kerr, Brockport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/252,913

(22) Filed: Sep. 23, 2002

(51) Int. Cl. B41J 2/01

(52) U.S. Cl. 347/101; 347/104

(57) ABSTRACT

A method of loading a medium onto an imaging drum (300) mounted for rotation about an axis, the imaging drum having force providing points to provide an attractive force between the imaging drum and the medium. The steps of the method are: rotating the imaging drum (300) about the axis into a position such that force providing points are located out of a medium load position in which the medium to be loaded first contacts the imaging drum; and maintaining the imaging drum (300) in the position until the medium is in the medium load position. With the medium in the medium load position, rotating the imaging drum about the axis such that the force providing points engage with the medium causing the medium to engage with the imaging drum. Once the medium has engaged with the imaging drum, the medium is allowed to move and the imaging drum is rotated such that the medium is wrapped around and loaded onto the imaging drum (300).

### FIELD OF THE INVENTION

The present invention relates to a method of loading media onto an imaging drum in an image processing apparatus. The invention includes a method of loading a medium onto an imaging drum in an image processing apparatus used to form a pre-press proof used in the printing industry.

### BACKGROUND OF THE INVENTION

Pre-press proofing is a procedure that is used mainly by the printing industry for creating representative images of printed material without the high cost and time that is required to actually produce printing plates and set up a high-speed, high volume, printing press to produce an example of an intended image. An image may require several corrections and be reproduced several times to satisfy or meet the customers requirements resulting in a large loss of profits and ultimately higher costs to the customer. An example of a system and method for pre-press proofing is described in commonly-assigned U.S. Pat. No. 5,341,159 or U.S. Pat. No. 5,268,708, the contents of which are incorporated herein by reference.

One such commercially available image processing apparatus is arranged to form an intended image on a sheet of thermal print medium. Dye is transferred from a sheet of dye donor material to the thermal print medium by applying a sufficient amount of thermal energy to the dye donor sheet material to form the intended image. This image processing apparatus generally includes a material supply assembly or carousel, and a lathe bed scanning subsystem or write engine, which includes a lathe bed scanning frame, translation drive, translation stage member, printhead, load roller, imaging drum, and thermal print medium and dye donor sheet material exit transports.

Operation of the image processing apparatus includes metering a length of the thermal print medium (in roll form) from the material assembly or carousel. The thermal print medium is then cut into sheet form of the required length and transported to the imaging drum. It is then wrapped around and secured onto the imaging drum. A load roller, which is also known as a squeegee roller, removes entrained air between the imaging drum and the thermal print medium or the thermal print medium and the dye donor material. Next, a length of dye donor material (in roll form) is metered out of the material supply assembly or carousel, and cut into sheet form of the required length. It is then transported to the imaging drum and wrapped around the periphery of the imaging drum. The load roller removes any air entrained between the imaging drum, thermal print medium and the dye donor material. The dye donor material is superposed in the desired registration with respect to the thermal print medium, which has already been secured to the imaging drum.

The thermal print medium and the dye donor sheet material must be located on the imaging drum must be precisely positioned requiring that the lead edge of the thermal print medium and the dye donor sheet material be accurately controlled during and after the loading of the thermal print medium and the dye donor sheet material.

After the dye donor sheet material is secured to the periphery of the imaging drum, the scanning subsystem or write engine provides the scanning function. This is accomplished by retaining the thermal print medium and the dye donor sheet material on the imaging drum while it is rotated past the printhead to form an intended image on the thermal print medium. The translation drive then traverses the printhead and translation stage member axially along the axis of the imaging drum in coordinated motion with the rotating imaging drum. These movements combine to produce the intended image on the thermal print medium.

After the intended image has been formed on the thermal print medium, the dye donor sheet material is removed from the imaging drum without disturbing the thermal print medium beneath it. The dye donor sheet material is then transported out of the image processing apparatus. Additional dye donor sheet materials are sequentially superimposed with the thermal print medium on the imaging drum, further producing an intended image. The completed intended image on the thermal print medium is then unloaded from the imaging drum and transported to an external holding tray on the image processing apparatus.

U.S. Pat. No. 5,777,658 discloses a system in which lift fins associated with the imaging drum are used to adjust the position of the medium relative to the imaging drum to enable the medium to be loaded and unloaded to the drum. However, although effective, this system requires the use of additional moving parts, which is undesirable.

### SUMMARY OF THE INVENTION

According to a first aspect of the present invention there is provided a method of loading a medium onto an imaging drum mounted for rotation about an axis, the imaging drum having force providing points to provide an attractive force between the imaging drum and the medium, the method comprising the steps of: rotating the imaging drum about said axis into a position such that the force providing points are located out of a medium load position in which the medium to be loaded first contacts the imaging drum; and maintaining the imaging drum in said position until the medium is in the medium load position.

Preferably, the method further comprises the steps of driving the medium to the imaging drum until the medium is in the medium load position; and once the medium is in the medium load position, rotating the imaging drum about the axis such that the force providing points engage with the medium causing the medium to engage with the imaging drum.

Once the medium has engaged with the imaging drum, the medium is allowed to move and the imaging drum is rotated such that the medium is wrapped around and loaded onto the imaging drum.

Preferably, the force-providing points are vacuum points in communication with the interior of the imaging drum, which is itself in communication with a vacuum source.

According to a second aspect of the present invention there is provided an imaging apparatus, comprising an imaging drum arranged for rotation about an axis, the imaging drum having force providing points to provide an attractive force between the imaging drum and a medium to be loaded thereon, wherein the imaging drum is controlled such that on loading of a medium, the drum is rotated abut the axis such that the force providing points are located out of a medium load position in which the medium to be loaded first contacts the imaging drum.

The invention provides a method of loading media onto an imaging drum that removes the need for the lift fins disclosed in U.S. Pat. No. 5,777,658, and also removes the need for the multi-chambered vacuum drum described in U.S. Pat. No. 5,341,159. In addition, the need for vacuum level control in the imaging drum as described in U.S. Pat. No. 6,266,076 is overcome. Instead the imaging drum is positioned such that the force-providing points, such as vacuum holes are located out of the medium load position. This enables the medium to be moved into the medium load position with little or no influence of the vacuum holes in the imaging drum. By enabling the medium to be moved into the medium load position with little or no influence of the vacuum holes in the imaging drum, media can be accurately and conveniently loaded onto an imaging drum.

Once the medium is driven into the correct medium load position it may be held in position by a media handling assembly including, for example, drive rollers, an articulating bar or other means known in the art. The imaging drum is moved into position such that as imaging drum moves the medium skids along the surface of the imaging drum until it is in the correct position, on the imaging drum so that the force-providing points engage with the medium. The medium is then allowed to move so that as the imaging drum rotates the medium is loaded onto the imaging drum. After the medium is loaded, the method may be repeated to load a second sheet of medium onto the imaging drum.

### BRIEF DESCRIPTION OF THE DRAWINGS

A more complete understanding of the invention and its advantages will be apparent from the detailed description taken in conjunction with the accompanying drawings, wherein examples of the invention are shown, and wherein:

FIG. 1 is a side view in vertical cross-section of an image processing apparatus suitable for use with the method of the present invention;

FIG. 2 is an exploded, perspective view of an imaging drum suitable for use in the image processing apparatus of FIG. 1;

FIGS. 3A to 3D show the steps required for loading of medium onto an imaging drum, in accordance with the method of the present invention;

FIG. 4 is a plan view of a imaging drum surface suitable for use in the image processing apparatus of FIG. 1;

FIGS. 5A to 5C are plan views of a imaging drum showing a sequence of placement for thermal print medium and dye donor sheet material according to the method of the present invention;

FIG. 6 is a schematic side elevation view of an image processing apparatus suitable for use with the method of the present invention; and

FIG. 7 is a front perspective view of a material supply carousel of a image processing apparatus shown in FIG. 6.

### DETAILED DESCRIPTION OF THE INVENTION

In the following description, like reference characters designate like or corresponding parts throughout the several views. Also, in the following description, it is to be understood that such terms as “front,” “rear,” “lower,” “upper,” and the like are words of convenience and are not to be construed as limiting terms. Referring in more detail to the drawings, the invention will now be described.

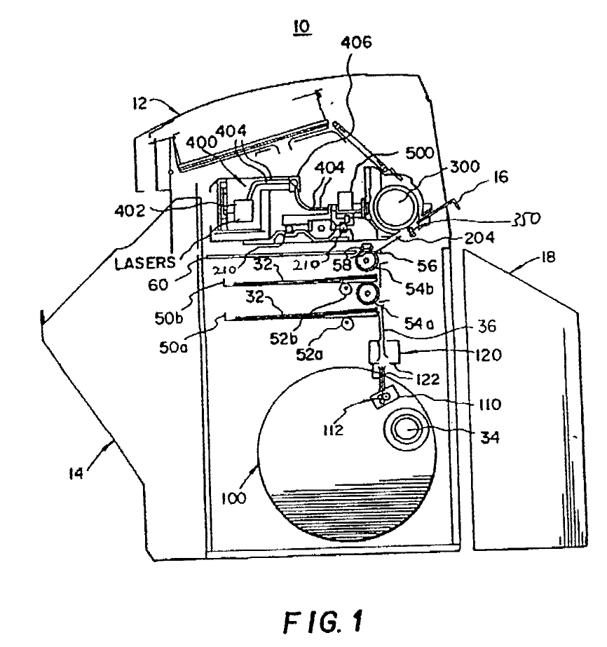

Turning first to FIG. 1, an image processing apparatus according to the present invention, which is generally referred to as 10, includes an image processor housing 12, which provides a protective cover for the image processing apparatus 10. The image processing apparatus 10 also includes a hinged image processor door 14, which is attached to the front portion of the image processor housing 12 and permits access to the two sheet material trays 50. A lower sheet material tray 50a and upper sheet material tray 50b are positioned in the interior portion of the image processor housing 12 for supporting thermal print medium 32, or an input image (not shown), thereon. Only one of the sheet material trays 50 will dispense the thermal print medium 32 out of the sheet material tray 50 to create an intended image (not shown) thereon. The alternate sheet material tray 50 a or b either holds an alternative type of thermal print medium 32, or an input image (not shown), or functions as a back up sheet material tray 50 for thermal print medium 32. In this regard, lower sheet material tray 50a includes a lower medium lift cam 52a, which is used to lift the lower sheet material tray 50a and, ultimately, the thermal print medium 32 upwardly toward lower medium roller 54a and upper medium roller 54b. When the medium rollers 54a and 54b are both rotated, the thermal print medium 32 is pulled upwardly towards a movable medium guide 56. The upper sheet material tray 50b includes an upper medium lift cam 52b for lifting the upper sheet material tray 50b and, ultimately, the thermal print medium 32 towards the upper medium roller 54b, which directs it toward the movable medium guide 56.

Continuing with FIG. 1, the movable medium guide 56 directs the thermal print medium 32 under a pair of medium guide rollers 58. This engages the thermal print medium 32 for assisting the upper medium roller 54b in directing the thermal print medium 32 onto medium staging tray 60. The medium guide 56 is attached and hinged to the lathe bed scanning frame 202 at one end, and is uninhibited at its other end for permitting multiple positioning of the medium guide 56. The medium guide 56 then rotates the uninhibited end downwardly, as illustrated. The direction of rotation of the upper medium roller 54b is reversed for moving the thermal print medium 32, which is resting on the medium staging tray 60, under the pair of medium guide rollers 58 upwardly through an entrance passageway 204 and up to an imaging drum 300 according to the present invention.

A media roll 30 of dye donor material 34 is connected to the medium carousel 100 in a lower portion of the image processor housing 12, as shown in FIG. 1. Four media rolls 30 are ordinarily used, but, for clarity, only one is shown in FIG. 1. Each media roll 30 includes a dye donor material 34 of a different color, typically black, yellow, magenta and cyan. The dye donor materials 34 are ultimately cut into dye donor sheet materials 36 and passed to the imaging drum 300 for forming the medium from which dyes embedded therein are passed to the thermal print medium 32. It should be noted that dye could take the form of pigments inks or colorants. In this regard, a medium drive mechanism 110 is attached to each media roll 30 of dye donor material 34, and includes three medium drive rollers 112 through which the dye donor material 34 of interest is metered upwardly into a medium knife assembly 120. After the dye donor material 34 reaches a predetermined position, the medium drive rollers 112 cease driving the dye donor material 34. Two medium knife blades 122 positioned at the bottom portion of the medium knife assembly 120 cut the dye donor material 34 into dye donor sheet materials 36. The lower medium roller 54a and the upper medium roller 54b along with the medium guide 56 then pass the dye donor sheet material 36 onto, medium staging tray 60 and ultimately to the imaging drum 300.

As shown in FIG. 1, a laser assembly 400 includes a quantity of laser diodes 402 in its interior. The laser diodes 402 are connected via fiber optic cables 404 to a distribution block 406 and ultimately to a printhead 500. The printhead 500 directs thermal energy received from the laser diodes 402 to the dye donor sheet material 36. This causes the dye donor sheet material 36 to pass the desired color to the thermal print medium 32. The printhead 500 attaches to a lead screw (not shown), which provides axial movement along the longitudinal axis of the imaging drum 300 for transferring the data to create the intended image onto the thermal print medium 32.

To form an intended image onto the thermal print medium 32, the imaging drum 300 rotates at a constant velocity. The printhead 500 begins at one end of the thermal print medium 32 and traverses the entire length of the thermal print medium 32 if needed for completing the transfer process for the particular dye donor sheet material 36 resting on the thermal print medium 32. After the printhead 500 completes the transfer process for the particular dye donor sheet material 36 resting on the thermal print medium 32, the dye donor sheet material 36 is removed from the imaging drum 300 and transferred out of the image processor housing 12 via a skive or ejection chute 16. The dye donor sheet material 36 eventually comes to rest in a waste bin 18 for removal by the user. The above-described process is then repeated for the other three media rolls 30 of dye donor materials 34. The thermal print medium 32 with the intended image thereon is then removed from the imaging drum 300 and transported out of the image processor housing 12.

Optionally the operation of the image processing apparatus 10 could include metering a length of the thermal print medium (in roll form) 32 from the medium carousel 100. The thermal print medium 32 is then measured and cut into sheet form of the required length and transported to the imaging drum 300. It is then registered, wrapped around, and secured onto the drum 300 using the load roller 350. Next, a length of dye donor material (in roll form) 34 is metered out of the medium carousel 100, measured, and cut into sheet form of the required length. Then transported to the imaging drum 300 and wrapped around the imaging drum 300 using the load roller 350, so that it is superposed in the desired registration with respect to the thermal print medium 32, which has already been secured to the imaging drum 300.

After the dye donor sheet material 36 is secured to the periphery of the imaging drum 300, a scanning system 210 such as a lathe bed scanning system or write engine provides the scanning function. This is accomplished by retaining the thermal print medium 32 and the dye donor sheet material 36 on the spinning imaging drum 300 while it is rotated past the printhead 500 that will expose the thermal print medium 32. The lead screw then traverses the printhead 500 axially along the axis of the imaging drum 300 in coordinated motion with the rotating imaging drum 300. These movements combine to produce the intended image onto the thermal print medium 32.

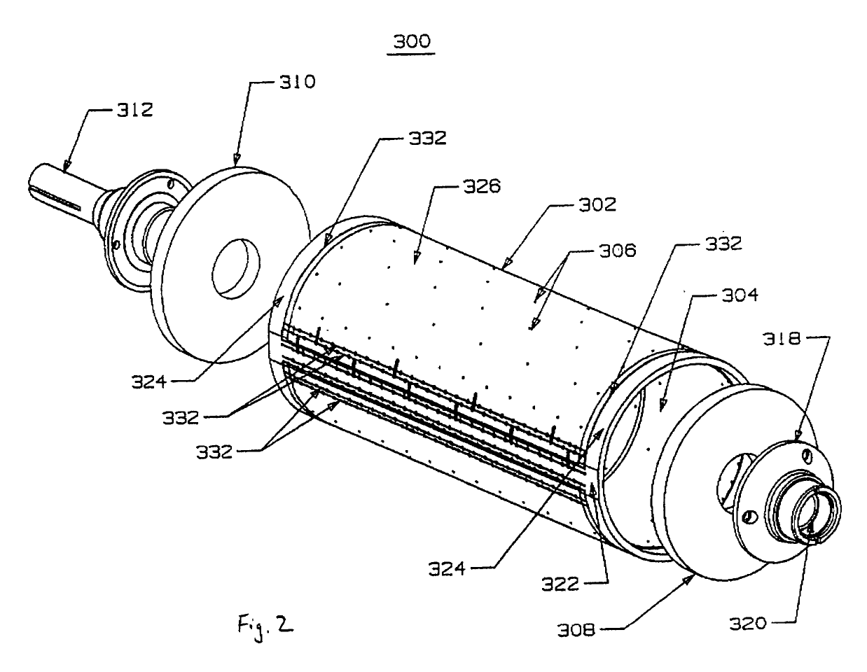

FIG. 2 shows an example of an imaging drum 300 for use in the image processing apparatus 10 of FIG. 1. The imaging drum 300 includes means for providing an attractive force between the imaging drum 300 and the medium. In this case, the imaging drum 300 has a cylindrical-shaped imaging drum housing 302, which includes a hollowed-out interior portion 304. The attractive force is provided by a number of vacuum holes 306 in the wall of the imaging drum 300 that communicate vacuum from interior of the imaging drum 300 to the exterior of the imaging drum 300. The imaging drum 300 further includes a number of vacuum grooves 332 on the surface of the imaging drum 300. Vacuum is applied from the hollow-out interior portion 304 of the imaging drum 300 through vacuum grooves 332 and the vacuum holes 306. The vacuum supports and maintains the position of the thermal print medium 32 and the dye donor sheet material 36, even as the imaging drum 300 rotates.

The ends of the imaging drum 300 are closed by a vacuum end plate 308, and a drive end plate 310. The drive end plate 310 is provided with a centrally disposed drive spindle 312, which extends outwardly. The vacuum end plate 308 is provided with a centrally disposed vacuum spindle 318 extending outwardly.

The imaging drum 300 is provided with vacuum by connection to a high-volume vacuum blower (not shown), which is capable of producing 50-60 inches of water at 60-70 CFM. The vacuum blower (not shown) provides the vacuum to the imaging drum 300 required during loading, scanning and unloading of the thermal print medium 32 and the dye donor sheet materials 36 to create the intended image.

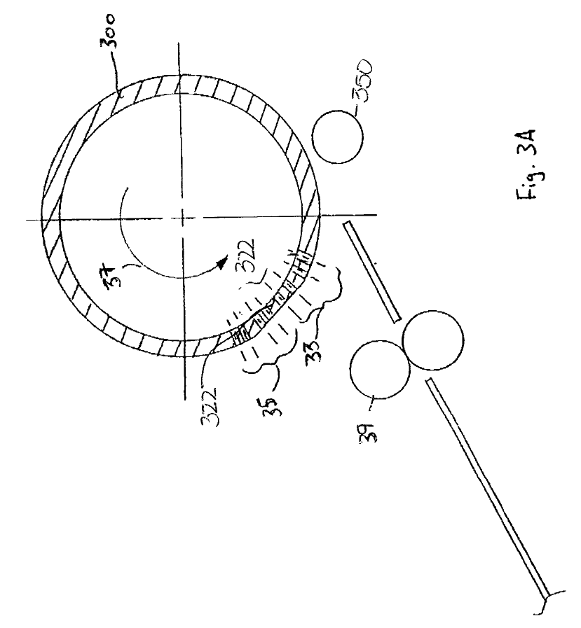

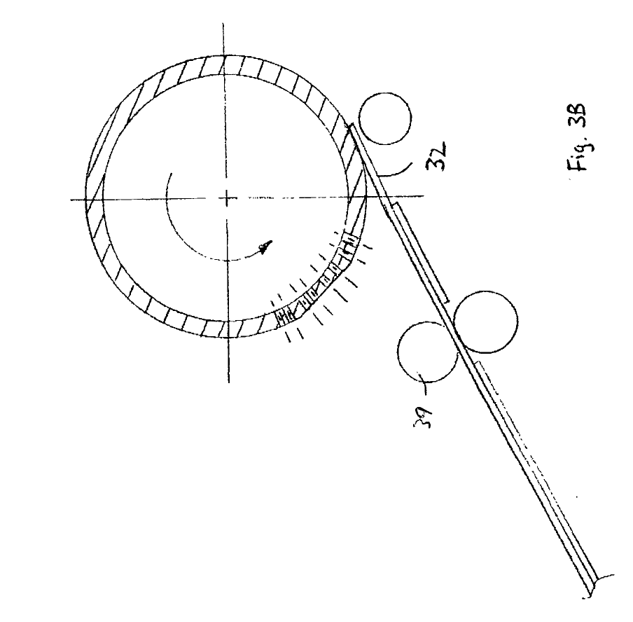

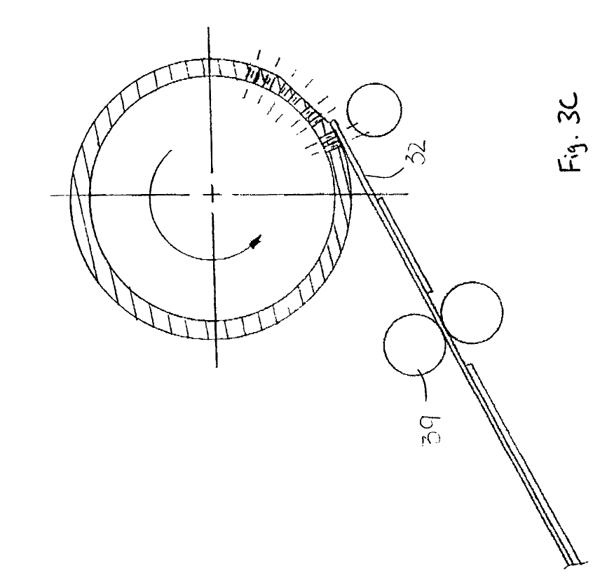

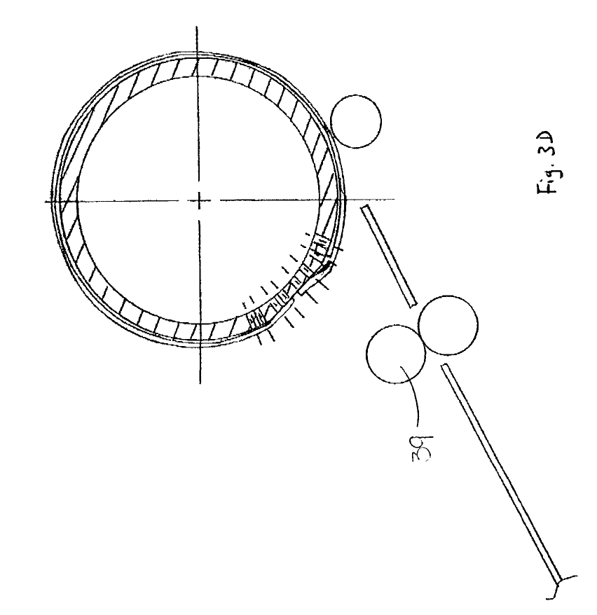

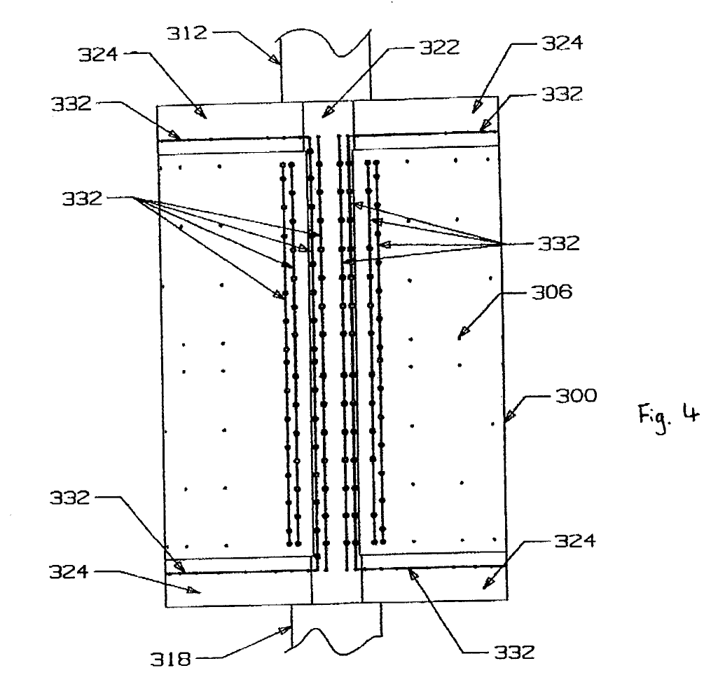

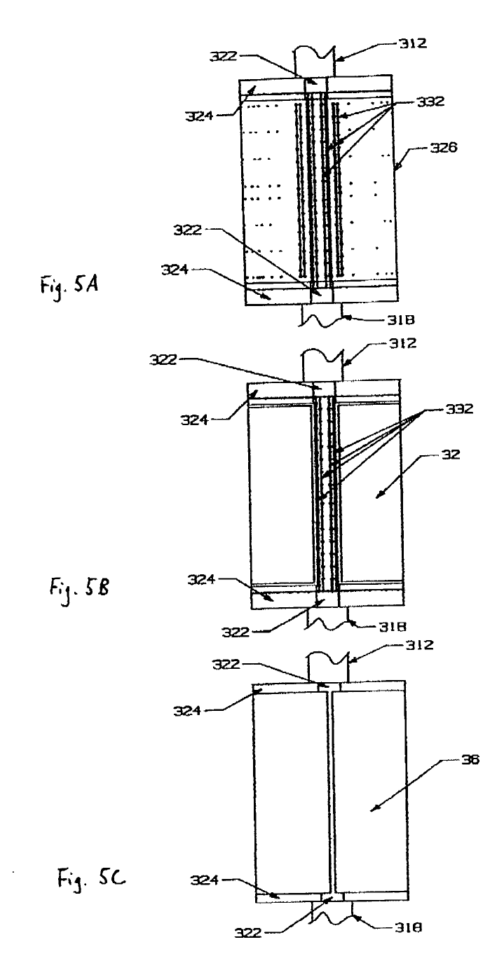

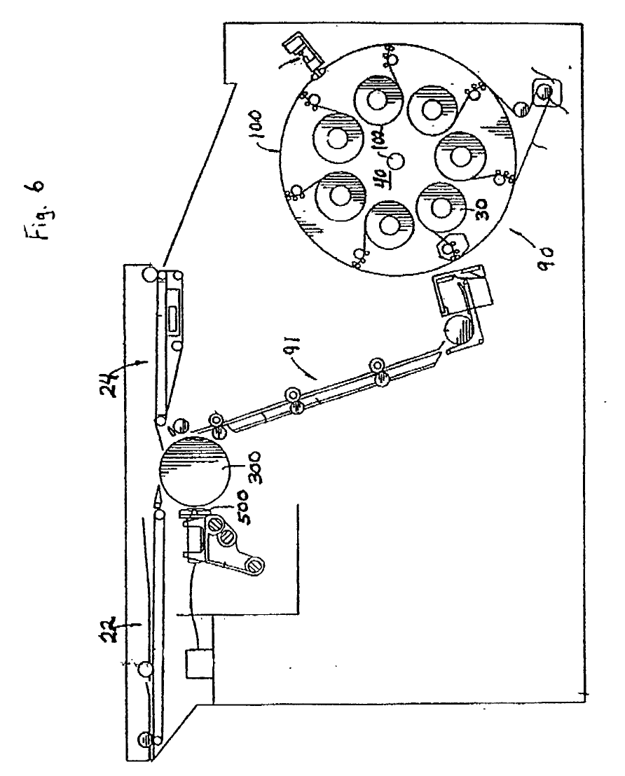

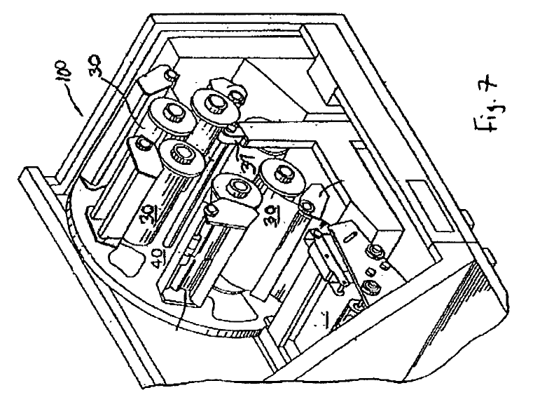

FIGS. 3A to 3D show the steps in the method of the present invention of loading thermal print medium 32 onto an imaging drum 300. In this case, the imaging drum 300 has an axially extending flat portion 322, which preferably extends approximately 8 degrees of the circumference of the imaging drum 300. A number of lead vacuum holes 33 and trail vacuum holes 35 are provided in the axially extending flat 322. The holes on the axially extending flat portion 322 are categorized as lead vacuum holes 33 and trail vacuum holes 35 with reference to their position relative to each other and their presentation to the thermal print medium 32 being loaded. It can be seen that as the imaging drum 300 rotates in the direction of arrow 37, the lead vacuum holes 33 are presented to the thermal print medium 32 before the trail vacuum holes 35.

Referring to FIG. 3A, a thermal print medium 32 (not shown in FIG. 3A) is loaded onto the imaging drum 300 with the help of a loading mechanism 39. Load roller 350 is optionally also provided. Prior to engagement of the thermal print medium 32 with the imaging drum 300 (the position in FIG. 3A) the imaging drum 300 is rotated about its longitudinal axis such that the lead vacuum holes 33 and trail vacuum holes 35 are not in the thermal print medium 32 load position. In other words, the lead vacuum holes 33 and trail vacuum holes 35 are positioned such that when the thermal print medium 32 is advanced by the loading mechanism 39 so that it is in close proximity to the imaging drum 300, the lead vacuum holes 33 and trail vacuum holes 35 do not interfere with the thermal print medium 32. With the imaging drum 300 in this position, the thermal print medium 32 is advanced into the thermal print medium 32 load position in which the leading edge of the thermal print medium 32 is in close proximity to the imaging drum 300. Although not necessarily stationary, the imaging drum 300 is maintained in a position with the force providing points out of the thermal print medium 32 load position.

Once the thermal print medium 32 is moved into the thermal print medium 32 load position as shown in FIG. 3B, the thermal print medium 32 is held in position by the loading mechanism 39. The loading mechanism 39 may include drive rollers, an articulating bar or any other suitable means known in the art which are not shown. With the thermal print medium 32 held in position, the imaging drum 300 is rotated about its longitudinal axis into position such that as imaging drum 300 rotates, the thermal print medium 32 skids along the surface thereof. Once the imaging 300 drum reaches the position shown in FIG. 3C, the thermal print medium 32 is released by the loading mechanism which enables the thermal print medium 32 to be loaded onto the imaging drum 300 as it continues to rotate. Once the thermal print medium 32 is loaded dye donor sheet materials 36 can be loaded using the same method so that the arrangement of FIG. 3D is achieved. The arrangement of FIG. 3D shows the thermal print medium 32 loaded onto the imaging drum 300 with a dye donor sheet material 36 loaded on top of thermal print medium 32.

In the example of an imaging drum 300 shown in FIG. 4, the outer surface of the imaging drum 300 is provided with an axially extending flat 322, which preferably extends approximately 8 degrees of the imaging drum 300 circumference. The imaging drum 300 is provided with donor support rings 324, which form a radial recess 326 (see FIG. 2). This recess extends radially from one side of the axially extending flat 322 around the imaging drum 300 to the other side of the axially extending flat 322, from approximately one inch from one end of the imaging drum 300 to approximately one inch from the other end of the imaging drum 300. Although a preferred embodiment herein does include an axially extending flat 322 and a radial recess 326, the present invention need not include either.

As shown in FIGS. 5A to 5C, the thermal print medium 32 when mounted on the imaging drum 300 is seated within the radial recess 326. Therefore, the donor support rings 324 have a thickness, which is substantially equal to the thickness of the thermal print medium 32 seated there between. In this embodiment, this thickness is 0.004 inches. The purpose of the radial recess 326 on the surface of the imaging drum 300 is to eliminate any creases in the dye donor sheet material 36, as the materials are drawn down over the thermal print medium 32 during the loading of the dye donor sheet material 36. This ensures that no folds or creases will be generated in the dye donor sheet material 36, which could extend into the image area and seriously adversely affect the intended image. The radial recess 326 also substantially eliminates the entrapment of air along the edge of the thermal print medium 32, the vacuum holes 306 in the imaging drum 300 surface cannot always ensure the removal of the entrapped air. Any residual air between the thermal print medium 32 and the dye donor sheet material 36 can also adversely affect the intended image.

An alternate example of an imaging system suitable for use with the method of the present invention is illustrated in FIG. 6: a laser thermal proofer 11. The laser thermal proofer 11 comprises generally a material supply assembly 90, a sheet cutter assembly 82, a sheet transport assembly 91, an imaging drum 300, a printhead 500, receiver exit assembly 22 and a donor exit assembly 24.

Referring to FIGS. 6 and 7, the material supply assembly 90 comprises a medium carousel 100 mounted for rotation about a horizontal axis 102 The medium carousel 100 comprises a vertical circular plate 40 having a plurality of material support spindles 42 cantilevered outwardly from and equally spaced about the front face of the vertical circular plate 40. Each of the material support spindles 42 is arranged to carry a media roll 30 of material for use on the imaging drum 300.

In an alternate method of loading medium onto the imaging drum 300, the imaging drum 300 is moved such that the load points are in the medium load position with no vacuum supplied to imaging drum 300 (vacuum blower off) once the thermal print medium 32 is moved to the correct position vacuum is applied (vacuum blower turned on) thus securing the thermal print medium 32. The imaging drum 300 then moves loading the thermal print medium onto the imaging drum 300. Next the dye donor sheet material 36 is loaded onto the imaging drum 300 using the method previously described.

The invention has been described in detail with particular reference to certain preferred embodiments thereof, but it will be understood that variations and modifications can be effected within the spirit and scope of the invention as described hereinabove and as defined in the appended claims by a person of ordinary skill in the art, without departing from the scope of the invention. While preferred embodiments of the invention have been described using specific terms, this description is for illustrative purposes only. It is intended that the doctrine of equivalents be relied upon to determine the fair scope of these claims in connection with any other person's product which fall outside the literal wording of these claims, but which in reality do not materially depart from this invention.

### Parts List

10. Image processing apparatus

11. Laser thermal proofer

12. Image processor housing

14. Hinged image processor door

16. Ejection chute

18. Wastebin

30. Media roll

32. Thermal print medium

33. Lead vacuum holes

34. Dye donor material

35. Trail edge vacuum holes

36. Dye donor sheet material

37. Arrow

39. Loading mechanism

40. Vertical circular plate

42. Material support spindles

50. Sheet material tray

50a. Lower sheet material tray

50b. Upper sheet material tray

52. Medium lift cam

52a. Lower medium lift cam

52b. Upper medium lift cam

54. Medium rollers

54a. Lower medium roller

54b. Upper medium roller

56. Movable medium guide

58. Medium guide rollers

60. Medium staging tray

80. Sheet cutter assembly

90. Material supply assembly

91. Sheet transport assembly

100. Medium carousel

102. Horizontal axis

110. Medium drive mechanism

112. Medium drive rollers

120. Medium knife assembly

122. Medium knife blades

204. Entrance passageway

210. Scanning system

300. Imaging drum

302. Imaging drum housing

304. Hollowed out interior portion

306. Vacuum holes

308. Vacuum end plate

310. Drive end plate

312. Drive spindle

318. Vacuum spindle

322. Axially extending flat

324. Donor support rings

326. Radial recess

332. Vacuum grooves

350. Load roller

400. Laser assembly

402. Laser diode

404. Fiber optic cables

406. Distribution block

500. Printhead

What is claimed is:

1. A method of loading a medium onto an imaging drum mounted for rotation about an axis, the imaging drum having force providing points to provide an attractive force between the imaging drum and the medium, the method comprising the steps of:
rotating the imaging drum about said axis into a position such that the force providing points are located out of a medium load position in which a medium to be loaded first contacts the imaging drum; and
maintaining the imaging drum in said position until the medium is in said medium load position.

2. A method according to claim 1, further comprising, after the step of rotating the imaging drum about said axis into a position such that the force providing points are located out of a medium load position, the steps of:
driving the medium to the imaging drum until the medium is in the medium load position; and
once said medium is in the medium load position, rotating the imaging drum about said axis so that the force providing points engage with said medium causing said medium to engage with said imaging drum.

3. A method according to claim 2, further comprising the steps of, once said medium has engaged with said imaging drum, allowing the medium to move; and
rotating the imaging drum about said axis such that the medium wraps around said imaging drum.

4. A method according to claim 1, in which the force providing points are vacuum points in communication with the interior of the imaging drum, which is itself in communication with a vacuum source.

5. A method according to claim 3, in which the medium is a thermal print medium.

6. A method according to claim 5, in which after said thermal print medium is loaded onto the imaging drum, a dye donor sheet is loaded thereon using the method of claim 1.

7. An imaging apparatus, comprising an imaging drum arranged for rotation about an axis, the imaging drum having force providing points to provide an attractive force between the imaging drum and a medium to be loaded thereon, wherein the imaging drum is controlled such that on loading of a medium, the drum is rotated abut said axis such that the force providing points are located out of a medium load position in which the medium to be loaded first contacts the imaging drum.
